(19) United States
(12) Patent Application Publication
(10) Pub. No.: US 2010/0175898 A1
(43) Pub. Date: Jul. 15, 2010

(54) FIRE PROTECTION SYSTEM FOR A CLOTHES DRYER

(75) Inventor: Jakob Steinicke, Vissenbjerg (DK)

Correspondence Address: PEARNE & GORDON LLP, 1801 EAST 9TH STREET, SUITE 1200, CLEVELAND, OH, 44114-3108, US

(73) Assignee: AKTIEBOLAGET ELECTROLUX, Stockholm (SE)

(21) Appl. No.: 12/594,852

(22) PCT Filed: Mar. 10, 2008
(86) PCT No.: PCT/EP08/01874

§ 371 Date: Mar. 22, 2010

(30) Foreign Application Priority Data
Apr. 12, 2007 (SE) 0700920-2

(51) Int. Cl. A62C 2/00

(52) U.S. Cl. 169/46; 34/544

(57) ABSTRACT

A fire protection system for a clothes dryer comprising a temperature sensitive device (1) for detecting a parameter related to temperature in the clothes dryer. The temperature sensitive device (1) is placed in an inner space (2) of the clothes dryer and is arranged connected to a fire extinguishing agent releasing device (3), wherein said temperature sensitive device (1) is capable of providing a pressure impulse or a mechanical impulse, when a predetermined value of the parameter is met. Said mechanical or pressure impulse ensures release of a fire extinguishing agent, by said fire extinguishing agent releasing device, or ensures cut off of release of said fire extinguishing agent.

### TECHNICAL FIELD

The present document relates to fire protection of clothes dryers.

More particularly, the present disclosure relates to a fire protection system, and methods for protecting a clothes dryer and the surrounding environment thereof from fire and also protection from possible damages caused by a fire extinguishing agent.

### BACKGROUND

It is well known that hazardous situations such as self-combustion can arise when a clothes dryer drying cycle has come to an end and the dryer is idle. This situation can e.g. arise when a clothes dryer is turned off at the end of the working day or at the end of a laundry room's or laundry facility's opening hours.

To protect the clothes dryer and the building where it is installed, and the people in the building, different approaches has been tried to ensure that the hazardous situation is discovered and controlled.

Previous systems for detecting and extinguishing fire in a clothes dryer are known in the art. Common to the below disclosed devices, systems and methods for actively extinguishing fires is that they employ an electrical power supply in order to operate as intended.

U.S. Pat. No. 6,505,418 discloses a clothes dryer having a fire protection system, which is controlled by a complex electronic controller that continuously monitors internal conditions and responds to a set of defined parameters. The disclosed system is dependent on an electric power supply in order for the controller to operate.

U.S. Pat. No. 7,013,577 discloses a system and method for testing a fire suppression system in a clothes dryer. The document describes a test button and a test cycle for the system described in U.S. Pat. No. 6,505,418 and a control system for operating the test cycle. The disclosed system depends on a microprocessor regulated control circuit and electronic sensors; hence electrical power must be connected.

U.S. Pat. No. 6,655,047 discloses a fire arrester for use with a clothes dryer including a fire detector, operating in the flow path of the dryer, which provides a disconnection of electrical power and/or optionally a release of an extinguishing agent or fire suppressant just prior to the shutting off the dryer blower. This system is dependent on an electronic controller and hence an electrical power supply and/or a back-up battery in order to operate properly.

All the systems above are dependent on electrical power to operate. The risk of a power cut or power failure is greatly increased in case of a fire, in particular there might be a risk of the power to the sensor or the system for extinguishing the fire being cut, or there might be a risk of a breakage of the electric cable to the sensor or the system. Consequently, to ensure a more safe system, it is desirable to have a system that operates independently of whether electrical power is available or not.

GB 2,079,911 discloses a tumble dryer having a heat-sensitive cut-out device, a thermal fuse, in communication with the air in the exhaust duct and connected to cut the power supply to at least the motor driving the fan if the temperature in the dryer reaches a critical level. The heat-sensitive cut-out device is independent of a functioning power supply. The system does however not actively extinguish fire in the dryer, but is used to cut the power to the motor driving the fan of the dryer in order to cut off the feed of fresh air.

There is hence a need for a fire protection system, which is safer in the sense that it operates independently of an electrical power supply.

### SUMMARY

It is an object of the present disclosure to provide an alternative and/or improved system for protecting a clothes dryer from fire, which eliminates or alleviates at least some of the disadvantages of the prior art.

More specifically, it is an object to provide a system and a method for protecting a clothes dryer from fire, which is independent of an electrical power supply and which actively tries to extinguish fire in the clothes dryer and protects the surrounding environment from fire and damages, which can be caused by the fire extinguishing agent.

The invention is defined by the appended independent claims. Embodiments are set forth in the appended dependent claims and in the following description and drawings.

According to a first aspect of the solution there is provided a fire protection system for a clothes dryer comprising a temperature sensitive device for detecting a parameter or a set of parameters related to temperature in the clothes dryer, and a fire extinguishing agent releasing device, the temperature sensitive device being arranged such that it is connected to the fire extinguishing agent releasing device, wherein said temperature sensitive device is capable of providing a pressure originated impulse or a mechanical impulse to the fire extinguishing agent releasing device, when a predetermined value or values of the parameter or set of parameters are met, for ensuring release of a fire extinguishing agent, by said fire extinguishing agent releasing device or for ensuring cut off of release of said fire extinguishing agent.

By the provision of a mechanical impulse or a pressure impulse from the temperature sensitive device, the need for an electric power supply is eliminated for the fire protections system to operate. Thereby the suppression or extinguishing of a fire in a clothes dryer may be provided even when there is a power failure or a power cut in e.g. a common laundry room. By the cut off function there may also be provided a way to prevent or limit damages on the clothes dryer and the surrounding environment caused by the fire extinguishing agent, when the fire has been put out.

By “a parameter related to temperature” is meant e.g. temperature or pressure. A predetermined level of the parameter may be a temperature level or pressure level that indicates that there is a fire in the clothes dryer and to which the temperature sensitive device can be set to act on.

By “clothes dryer” is meant e.g. a tumble-drier or a drying chamber or drying cupboard.

By “fire extinguishing agent” is meant any agent that effectively can extinguish and/or reduce fire.

The temperature sensitive device according to the first aspect of the solution may be a thermostatic valve, giving rise to a pressure impulse.

By the thermostatic valve there is provided a way of generating a pressure impulse to the fire extinguishing agent releasing device, when the parameter reaches a value predetermined for the valve as being abnormal. When the predetermined value is met, a pressure increase will occur in the valve that has the ability to open the device. The valve can be arranged integrally with the fire extinguishing agent releasing device, for releasing a fire extinguishing agent into the clothes dryer.

The temperature sensitive device may be a device capable of shifting shape, said shape shifting giving rise to a mechanical impulse.

By the shape shifting device there is provided a way of generating a mechanical impulse, which may act as a releasing movement for the fire extinguishing agent releasing device.

The fire extinguishing agent releasing device according to the first aspect may be a valve.

By the provision of a valve as a releasing device there is provided a way of integrating the temperature sensitive device with the releasing device, which creates a more secure release functionality.

The temperature sensitive device and the fire extinguishing agent releasing device according to the first aspect of the solution may be arranged integrally.

By arranging the temperature sensitive device and the fire extinguishing agent releasing device integrally the risk of the fire extinguishing agent not being able to reach the fire may be reduced, this allows a more secure functionality of the fire protection system.

The fire extinguishing agent may be tap water under normal tap water pressure.

By providing tap water as the fire extinguishing agent there is provided an agent, which is normally available in the surrounding of the clothes dryer, and normal tap water pressure is almost always sufficient pressure for the system to operate. Water is also an excellent fire extinguisher for clothes and lint that may have caught fire in the clothes dryer.

The fire extinguishing agent may be a chemical fire extinguishing agent arranged in a pressurized container.

The provision of a chemical fire extinguishing agent is convenient for those premises where tap water may not be possible, or is difficult, to connect to the clothes dryer.

The fire extinguishing agent may be externally connected to the clothes dryer.

The fire extinguishing agent may be distributed into the clothes dryer by a nozzle.

By distributing the agent through a nozzle a more safe and rapid extinguishment may be carried out.

In the clothes dryer there may also be provided a second temperature sensitive device providing a visual alarm and/or an audible alarm, said second temperature sensitive device operating independently of a first temperature sensitive device.

By the provision of second temperature sensitive device acting as a sensor for an alarm function it may be possible for an operator to more quickly attend to the possible fire situation. In the case of a power loss, the fire protection system will however be able to operate independently of this second temperature sensitive device and alarm.

The second temperature sensitive device may be activated at a predetermined value set at a lower level than the than the predetermined value level for the temperature sensitive device.

By the provision of a second temperature sensitive device which sets off an alarm at e.g. a temperature lower than a fire indicating temperature an operator may receive an early warning that there is a risk of a fire starting in the clothes dryer and may therefore be able to stop the fire at an early stage.

According to a second aspect of the present solution there is provided a method for protecting a clothes dryer from fire, comprising the steps of: detecting a parameter related to temperature in a clothes dryer by a temperature sensitive device; providing a mechanical impulse or a pressure impulse by the temperature sensitive device to a fire extinguishing agent releasing device, if said parameter meets a predetermined value; releasing, into the clothes dryer, a fire extinguishing agent from a fire extinguishing agent releasing device, through the provided mechanical impulse or pressure impulse.

According to this method of the present solution there is provided a method for detecting and extinguishing fire without the need for an external power supply, such that the method works even when there is a power failure or when the power ha been cut in, e.g. a common laundry room.

The released fire extinguishing agent according to the second aspect may be distributed in the clothes dryer through a nozzle.

By this method the fire extinguishing agent may be distributed in the clothes dryer uniformly to ensure a more rapid extinguishing of the fire.

The method according to the second aspect of the invention may comprise the step of providing a visual and/or audible alarm when a predetermined parameter value is met.

By the provision of a visual and/or audible alarm, it may be possible for an operator to more quickly attend to the possible fire situation.

The method may comprise the step of providing the alarm when the parameter meets another predetermined value lower than said predetermined value.

By the provision of a method where an alarm sets off at e.g. a temperature lower than a fire indicating temperature, an operator may receive an early warning that there is a risk of a fire starting in the clothes dryer and may therefore be able to stop the fire at an early stage.

The method according to the second aspect of the invention may further comprise the step of detecting a parameter related to temperature by a second temperature sensitive device that operates independently of said temperature sensitive device.

By the second temperature sensitive device being independent of the first temperature sensitive device there is provided a back-up for the first temperature sensitive device, if this for some reason is inoperative.

The second system may be set to respond to a different parameter than the first system, or may be set to respond to the same parameter but at a different level, which provides a more safe system. The alarm function provided by the second temperature sensitive device is meant as a complement to the first fire protection system, which operates without the connection of a power supply and without an input signal from the alarm provided by the second temperature sensitive device.

According to a third aspect of the present solution there is provided a method for protecting a clothes dryer and surrounding environment from damage caused by a fire extinguishing agent, comprising the steps of: detecting a parameter related to temperature in the clothes dryer by a temperature sensitive device; providing a mechanical impulse or a pressure impulse by the temperature sensitive device to a fire extinguishing agent releasing device, if the parameter meets a predetermined value, and cutting off any release of the fire extinguishing agent by a fire extinguishing agent releasing device, through the mechanical impulse or pressure impulse.

By cutting off any release of fire extinguishing agent when a predetermined value of a parameter related to temperature is met, there is ensured that an excessive amount of fire extinguishing agent is not released after fire has been extinguished, which may cause damages to the clothes dryer and the surrounding environment.

### BRIEF DESCRIPTION OF THE DRAWING

Embodiments of the present invention will now be described, by way of example, with reference to the accompanying schematic drawing in which:

FIG. 1 is a schematic drawing of a clothes dryer having a fire protection system.

### DESCRIPTION OF EMBODIMENTS

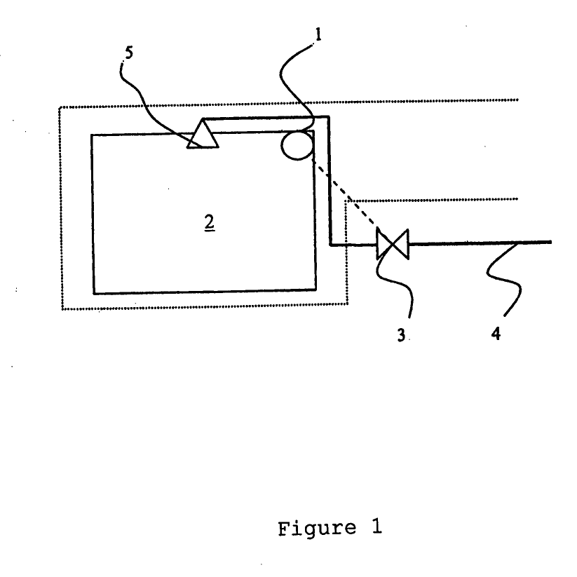

FIG. 1 illustrates schematically a clothes dryer having a fire protection system according to an embodiment of the invention. The clothes dryer has an inner space 2 adapted to receive clothes to be dried. The fire protection system comprises a temperature sensitive device 1 arranged in the clothes dryer, preferably in the inner space 2 of the clothes dryer, to detect a parameter related to temperature in the clothes dryer. The fire protection system also comprises a supply line 4 for supplying fire extinguishing agent, a fire extinguishing agent releasing device 3 for regulating release of the fire extinguishing agent in the supply line 4, and a nozzle 5 arranged in the inner space 2 at an end of the supply line 4, through which nozzle 5 the fire extinguishing agent is directed into the inner space 2 of the clothes dryer. The temperature sensitive device 1 is connected to the fire extinguishing agent releasing device 3 as shown by the dotted line in the FIGURE, for controlling the fire extinguishing agent releasing device 3.

The temperature sensitive device 1 may according to one embodiment be a thermostatic valve, which provides a pressure impulse to a fire extinguishing agent releasing device 3, the mechanism for the provision of a pressure impulse from the thermostatic valve is known to those skilled in the art. The pressure impulse created by the temperature sensitive device 1 interacts with the fire extinguishing agent releasing device 3 to release or cut off the release of fire extinguishing agent.

The temperature sensitive device 1 may also be, according to an alternative embodiment, a shape shifting device, which provides a mechanical impulse to the fire extinguishing agent releasing device 3. The shape shifting device 1 may according to one embodiment be formed from a bimetal, whereby an increase or decrease in temperature causes the bimetal to change form and thereby creating a mechanical impulse which interacts with the fire extinguishing agent releasing device 3 to release or cut off the release of the fire extinguishing agent.

The shape shifting device may also be formed from any other material, which is known to those skilled in the art, e.g. a fusible plug.

The fire extinguishing agent releasing device 3 may according to one embodiment be arranged integrally with the temperature sensitive device 1 (not shown in the FIGURE).

According to an alternative embodiment, the temperature sensitive device 1 and the fire extinguishing agent releasing device 3 may be arranged separately, e.g. as a thermostatic valve 1 with a bulb which is connected to the fire extinguishing agent releasing device 3 through a capillary tube.

The fire extinguishing agent releasing device 3 may according to one embodiment be a valve.

The fire extinguishing agent according to one embodiment is tap water under normal tap water pressure, which is sufficient pressure to ensure the release of the agent if an abnormal situation is detected.

According to an alternative embodiment the fire extinguishing agent is a chemical agent arranged in a pressurized container.

In one embodiment the fire extinguishing agent is arranged externally and is fed through the supply line 4 via the fire extinguishing releasing device 3 and the nozzle 5 into the inner space 2 of the clothes dryer. The nozzle 5 may be arranged in the inner space 2 to distribute the released fire extinguishing agent into the inner space 2 of the clothes dryer.

In one embodiment the nozzle 5 is arranged at the topmost part of the inner space of the clothes dryer 2.

According to one embodiment the fire extinguishing agent releasing device 3 is a valve for the release and cut off of fire extinguishing agent from the supply line 4. The supply line 4 feeds fire extinguishing agent to the clothes dryer, when the valve 3 has been opened. When the predetermined value or values of the parameter or parameters are met for the temperature sensitive device 1, it provides an impulse to the fire extinguishing agent releasing device 3, to open so that fire extinguishing agent, e.g. water, may flow in the supply line 4 through the valve 3 and on to the nozzle 5, where it is distributed in the inner space 2 of the clothes dryer. During the distribution of the fire extinguishing agent in the inner space 2 of the clothes dryer, the temperature sensitive device 1 continues to detect the parameter or set of parameters related to temperature, and when the parameter or set of parameters has lowered such that it reaches a predetermined value, the temperature sensitive device 1 provides the fire extinguishing agent releasing device 3 with an impulse which closes the fire extinguishing agent releasing device 3, and hence cuts off the release of fire extinguishing agent.

According to an alternative embodiment, the fire extinguishing agent releasing device 3 and the temperature sensitive device 1 may be arranged integrally as a glass plate that at a high temperature cracks and releases the fire extinguishing agent.

The temperature sensitive device 1 may according to yet an alternative embodiment be a liquid filled glass bulb, which is pressurized. In the liquid filled glass bulb there is a small air bubble incorporated. The pressure in the bulb is dependent on the surrounding temperature and when a certain temperature level is met, the pressure becomes high enough for the bulb to crack, which leads to the release of the fire extinguishing agent, through the fire extinguishing agent releasing device 3, which may be arranged integrally with the glass bulb 1. In this case the parameter related to temperature will be a pressure in the glass bulb, and when a certain pressure level is met, corresponding to a certain temperature level, the bulb cracks.

The fire releasing agent may also according to yet an alternative embodiment be arranged internally in the clothes dryer, e.g. as a pressurized container arranged in the inner space 2 of the clothes dryer (not shown).

In one embodiment the clothes dryer is provided with a second temperature sensitive device (not shown in the FIGURE). The second temperature sensitive device is capable of detecting a value of a parameter related to temperature, and the value is compared to a predetermined value that is lower than the predetermined value of the first temperature sensitive device 1. The detection of this value by the second temperature sensitive device gives rise to an alarm. The alarm may be visual and/or audible.

In one embodiment, the second temperature sensitive device is dependent on an electrical power supply to operate and provide the visual and/or audible signal.

The first temperature sensitive device 1 operates independently from the second temperature sensitive device.

In one embodiment the temperature sensitive devices are arranged separately.

In an alternative embodiment the temperature sensitive devices are arranged integrally.

The clothes dryer might be any kind of clothes dryer, such as a drying chamber or cupboard or a tumble-drier. In the case of the clothes dryer being a tumble-drier, the inner space 2 is preferably a drum of the tumble-drier, arranged for receiving clothes to be dried, and arranged for being rotated when clothes are dried in the tumble-drier.

1. A fire protection system for a clothes dryer, comprising a temperature sensitive device (1) for detecting a parameter or a set of parameters related to temperature in the clothes dryer, and a fire extinguishing agent releasing device (3), the temperature sensitive device (1) being arranged such that it is connected to the fire extinguishing agent releasing device (3), characterized in that
said temperature sensitive device (1) is capable of providing a pressure originated impulse or a mechanical impulse to the fire extinguishing agent releasing device (3), when a predetermined value or values of the parameter or set of parameters are met, for ensuring release of a fire extinguishing agent, by said fire extinguishing agent releasing device (3), or for ensuring cut off of release of said fire extinguishing agent.

2. A fire protection system according to claim 1, wherein the temperature sensitive device (1) is a thermostatic valve giving rise to a pressure impulse.

3. A fire protection system according to claim 1, wherein the temperature sensitive device (1) is a device capable of shifting shape, said shape shifting giving rise to a mechanical impulse.

4. A fire protection system according to claim 1, wherein the fire extinguishing agent releasing device (3) is a valve.

5. A fire protection system according claim 1, wherein the temperature sensitive device (1) and the fire extinguishing agent releasing device (3) are arranged integrally.

6. A fire protection system according to claim 1, wherein the fire extinguishing agent is tap water under normal tap water pressure.

7. A fire protection system according to claim 1, wherein the fire extinguishing agent is a chemical fire extinguishing agent arranged in a pressurized container.

8. A fire protection system according to claim 1, wherein the fire extinguishing agent is externally connected to the clothes dryer.

9. A fire protection system according to claim 1, wherein the fire extinguishing agent is distributed into the clothes dryer via a supply line (4) and a nozzle (5) arranged at an end of the supply line (4).

10. A fire protection system according to claim 1, wherein there is provided a second temperature sensitive device providing a visual alarm and/or an audible alarm, said second temperature sensitive device operating independently of said temperature sensitive device (1).

11. A fire protection system according to claim 10, wherein the second temperature sensitive device is activated at a predetermined value set at a lower level than the predetermined value for the temperature sensitive device (1).

12. A method for protecting a clothes dryer from fire, characterized in that it comprises the steps of:
detecting a parameter related to temperature in a clothes dryer by a temperature sensitive device (1);
providing a mechanical impulse or a pressure impulse by the temperature sensitive device (1) to a fire extinguishing agent releasing device (3), if said parameter meets a predetermined value;
releasing, into the clothes dryer, a fire extinguishing agent from a fire extinguishing agent releasing device (3), through the provided mechanical impulse or pressure impulse.

13. Method according to claim 12, wherein said released fire extinguishing agent is distributed in the clothes dryer through a nozzle (5).

14. Method according to claim 12, comprising the step of providing a visual and/or audible alarm when a second predetermined parameter value is met.

15. Method according to claim 14, wherein the second predetermined parameter value is lower than said predetermined value.

16. Method according to claim 12, further comprising the step of: detecting a parameter related to temperature by a second temperature sensitive device that operates independently of said temperature sensitive device (1).

17. A method for protecting a clothes dryer and surrounding environment from damage caused by a fire extinguishing agent, characterized in that it comprises the steps of:
detecting a parameter related to temperature in the clothes dryer by a temperature sensitive device (1);
providing a mechanical impulse or a pressure impulse by the temperature sensitive device (1) to a fire extinguishing agent releasing device (3), if the parameter meets a predetermined value; and
cutting off any release of the fire extinguishing agent by the fire extinguishing agent releasing device (3), through the provided mechanical impulse or pressure impulse.
